(19) United States
(12) Patent Application Publication
(10) Pub. No.: US 2003/0108760 A1
(43) Pub. Date: Jun. 12, 2003

(54) Production process for laminated materials based on wood veneer

(76) Inventors: Peter Haas, Haan (DE); Ernst-Martin Hoppe, Bergisch Gladbach (DE); Donald-Richard Larimer, Bergisch Gladbach (DE); Andreas Pielasch, Koln (DE)

Correspondence Address: BAYER POLYMERS LLC, 100 BAYER ROAD, PITTSBURGH, PA, 15205, US

(21) Appl. No.: 10/313,610

(22) Filed: Dec. 6, 2002

(30) Foreign Application Priority Data
Dec. 10, 2001 (DE) 10160572.2

(51) Int. Cl. B32B 21/04

(52) U.S. Cl. 428/537.1

(57) ABSTRACT

Multi-ply laminated materials based on wood veneer are produced by pressing veneer woods glued with a specified binder which enhances the cold bond strength of the laminate.

### BACKGROUND OF THE INVENTION

The invention relates to a process for the production of multi-ply laminated materials based on wood veneer by pressing veneer woods glued with binder, in which the cold bond strength of the laminates is increased due to use of a specific type of binder.

Pressed materials produced as finishing products from veneers of wood species from all growing regions (for example pine, okoumé, poplar) and binders are processed by pressing at different temperatures to obtain wood laminates such as laminated veneer lumber (LVL), laminated wood panels, plywood panels, star plywood panels or blackboard panels. They have a significant role as high-quality materials for the furniture, construction and packaging markets.

Amino resins (urea-formaldehyde resin (UF), melamine-urea-formaldehyde resin (MUF)) and phenolic resins (PF) are important binders for the production of these laminates. Disadvantages of these condensation resins are the sometimes long press times (MUF, PF), dark glue lines (PF) and high pressing temperatures (MUF, PF) as well as unsatisfactory water resistance (UF).

The aforementioned disadvantages can, on the other hand, be avoided with PU plywood binders. However, these PU binders in turn have the disadvantage of very poor cold bond strength of the glued laminated materials as well as penetration of the binder to the surface of the face layer of the plywood (“binder strike-through”). For instance, pMDI soaks completely into the wood veneers without forming a satisfactory glue line on the surface of the veneer.

Various proposals have been made to resolve this problem. In accordance with EP-A 352 558, the cold bond strength is improved by the use of polyisocyanates, compounds having at least two isocyanate-reactive hydrogen atoms, and alkylene carbonates. EP-A 93 357 describes prepolymers based on urethane-modified diphenylmethane diisocyanates as binders. WO 99/19141 mentions binders prepared from diphenylmethane diisocyanates and isocyanate-reactive polymers for plywood production by veneer pressing. However, the initial strength in the cold state, in particular, leaves something to be desired.

### SUMMARY OF THE INVENTION

It has now been found that the cold bond strength during processing of the glued veneers can be improved considerably if a pMDI prepolymer having urethane groups (preferably urethane groups formed by reaction of isocyanate groups with an EO-rich (ethylene oxide rich) hydroxy-functional polyether) is used as the binder.

### DETAILED DESCRIPTION OF THE INVENTION

The present invention provides a process for the production of pressed materials based on multi-ply wood veneers and a prepolymer as the binder, in which the prepolymer has urethane groups and an NCO content of from 20 to 31 wt. %. Such prepolymer binders are obtainable by reaction of a polyisocyanate of the diphenylmethane diisocyanate series with a hydroxy-functional polyether having an EO content of more than 60 wt. %, in relation to the total quantity of alkylene oxides used for the preparation of the polyether.

For the preparation of the prepolymers, polyisocyanates of the diphenylmethane diisocyanate series such as polyphenyl polymethylene polyisocyanates, e.g., those prepared by aniline-formaldehyde condensation followed by phosgenation (“raw MDI”) are used. Preferably, higher-nuclear isocyanates of the diphenylmethane diisocyanate series (pMDI products) are used as the polyisocyanate component. Particularly preferred polyisocyanate prepolymers have a monomeric diphenylmethane diisocyanate content of less than 55 wt. %.

The prepolymer is obtained by reaction of a polyisocyanate with a hydroxy-functional polyether having an EO content of more than 60 wt. %, preferably more than 70 wt. %, in relation to the total quantity of alkylene oxide used for the preparation of the polyether. The hydroxy-functional polyethers useful in the present invention generally have from 1 to 8, preferably from 2 to 6, OH groups. They preferably have number average molecular weights of from 400 to 10,000 g/mol, particularly preferably from 1,000 to 8,000 g/mol. Poly(oxypropylene polyoxyethlene) polyols are most preferably used.

The hydroxy-functional polyethers may be prepared by known processes, for example by anionic polymerization of an alkylene oxide in the presence of a starter compound having active hydrogen atoms. Suitable alkylene oxides include those having from 2 to 4 carbon atoms in the alkylene radical. Examples, in addition to ethylene oxide, are tetrahydrofuran, 1,2-propylene oxide, 1,2- and 2,3-butylene oxide. Ethylene oxide (EO) and 1,2-propylene oxide (PO) are particularly preferred. The alkylene oxides may be used alternately, sequentially or as mixtures.

Compounds having (number average) molecular weights of from 18 to 2,000 g/mol and having from 1 to 8 hydroxyl groups are preferably used as starter compounds having active hydrogen atoms. Examples are ethylene glycol, diethylene glycol, triethylene glycol, 1,2-propylene glycol, 1,4-butanediol, hexamethylene glycol, bisphenol A, trimethylolpropane, glycerol, pentaerythritol, sorbitol, cane sugar, degraded starch and water. Oligomeric alkoxylation products of the low molecular weight starters mentioned previously having (number average) molecular weights of from 200 to 2,000 g/mol may also be used as starter compounds.

The reaction of polyisocyanate and hydroxy-functional polyether generally takes place at temperatures of from 20 to 120° C. The polyisocyanate and hydroxy-functional polyether are used in quantitative ratios such that the prepolymer formed has an NCO content of from 20 to 31 wt. %, preferably 22 to 28 wt. %. The prepolymers preferably have an equivalent weight of from 250 to 5,000 g/mol.

Suitable raw materials which can be bonded with the binder in accordance with the present invention are wood veneers, for example of woods from the Boreal, sub-tropical or tropical regions. Plastic materials may additionally also be used in combination with these woods. These plastic materials may be present in the form of thin laminates, sheets or foils. Papers, cellulose, woven webs and non-wovens as well as cross-band veneers or face veneers may also be used to construct the laminates.

The raw material is supplied with the binder in a quantity of from 40 to 250 g/m², preferably 60 to 180 g/m² of wood surface area and, generally under the influence of pressure and heat (for example, at a temperature of from 70 to 250° C. and specific pressure from 1 to 50 bar), is pressed to obtain panels or formed bodies. The procedure here is frequently such that an uneven number of veneers are used to produce the plywood. In this case, thinner veneers are frequently used for the outer plies than for the core of the plywood. Only the even-numbered plies are supplied on both sides with the binder. The veneer plies are bonded together to obtain a plywood by assembling, blocked together, the alternately glued and unglued layers, followed by hot pressing. In the case of LVL, on the other hand, all the veneers are laid parallel in the direction of production and are hot-pressed after the continuous pre-treatment.

Gluing is normally carried out using a 4-roll gluing machine. Just like condensation resins, PU binders according to the invention can also be applied by this application technique as well as by other techniques such as coating, spraying (airless, two-component) or knife application.

In one embodiment of the invention, the veneers are supplied with water (in the form of a spray mist) following gluing. The quantity of water may be up to 150 g per m² of laminate surface area, preferably from 10 g/m² to 80 g/m². In order to avoid premature curing of the binder (so as to extend the pot life), as well as to adjust the individual viscosity of the PU binder precisely, a zeolite may be added to the binder. The quantity to be added may be from 0.3 to 25 wt. %, in relation to the total quantity of binder, but is preferably from 1 to 5 wt. %.

The glued and unglued veneer plies are joined together subsequently to obtain a bond by pre-pressing, so that the plywood, which still has to be hot-pressed, can be transported into the hot press without problems. The cold pre-press which has spacing control is closed to within approx. 0.1 to 0.4 mm above the calculated total of all the veneer plies, and consequently leads not to compression but only to a bonding of the veneer system. The bond must have sufficient cold bond strength to be transportable into the hot press.

In the subsequent hot pressing at from 70° C. to 200° C., the veneer plies are bonded together with the binder which cures at elevated temperature. Since the PU binder which is used contains no water, the water content of the veneer plies can be adjusted precisely to meet individual requirements by means of the drying process or the addition of spray water. Productivity increases can consequently be achieved by shortening the pressing process thanks to an optimal water content.

Having thus described the invention, the following Examples are given as being illustrative thereof.

### EXAMPLES

A. Prepolymers

For preparation of the prepolymers used in the Examples which follow, the respective components were mixed and then annealed at 95° C. for two hours, with continuous stirring.

Prepolymer 1

Prepolymer prepared from 840 g of a polymeric MDI (pMDI) having an NCO content of approx. 31.5 wt. % (Desmodur® 1520 A20, Bayer AG) and 210 g of a polyether polyol started with glycerol and having an OH number of 36 and 85% primary OH groups, PO/EO ratio 28 wt. %/72 wt. %. The prepolymer had an NCO content of 24.5 wt. % and a viscosity of 1400 mPa.s (25° C.).

Prepolymer 1 A

50 g zeolite L (UOP-L powder, UOP GmbH, D-51368 Leverkusen) were dispersed in 950 g of Prepolymer 1.

Prepolymer 1 B

100 g zeolite L (UOP-L powder, UOP GmbH, D-51368 Leverkusen) were dispersed in 900 g of Prepolymer 1.

Prepolymer 1 C

150 g zeolite L (UOP-L powder, UOP GmbH, D-51368 Leverkusen) were dispersed in 850 g of Prepolymer 1.

Prepolymer 2

Prepolymer prepared from 840 g of Desmodur® 1520 A20 pMDI and 160 g of a polyether polyol started with sorbitol and having an OH number of 100 and 90% primary OH groups, PO/EO ratio 18 wt. %/82 wt. %. The prepolymer had an NCO content of 25.5 wt. % and a viscosity of 2500 mPa.s (25° C.).

Prepolymer 3

Prepolymer prepared from 775 g of Desmodur® 1520 A20 pMDI and 225 g of a polyether polyol started with butyldiethylene glycol and having an OH number of 25 and 90% primary OH groups, PO/EO ratio 15 wt. %/85 wt. %. The prepolymer had an NCO content of 23.4 wt. % and a viscosity of 620 mPa.s (25° C.).

Prepolymer 4

Prepolymer prepared from 266 g of Desmodur® 1520 A20 pMDI and 60 g of a polyethylene oxide started with ethylene glycol and having an OH number of 73. The prepolymer had an NCO content of 24.3 wt. % and a viscosity of 1300 mPa.s (25° C.).

Prepolymer 5

Prepolymer prepared from 840 g of Desmodur® 1520 A20 pMDI and 160 g of a polyether polyol started with propylene glycol and having an OH number of 185 and more than 90% primary OH groups, PO/EO ratio 3 wt. %/97 wt. %. The prepolymer had an NCO content of 24.1 wt. % and a viscosity of 3100 mPa.s (25° C.).

Prepolymer 6 (Comparison)

Prepolymer prepared from 1200 g of Desmodur® 1520 A20 pMDI and 300 g of a polyether polyol started with trimethylolpropane and having an OH number of 28 and 85% primary OH groups, PO/EO ratio 85 wt. %/15 wt. %. The prepolymer had an NCO content of 24.4 wt. % and a viscosity of 1240 mPa.s (25° C.).

Prepolymer 7 (Comparison)

Prepolymer prepared from 1200 g of Desmodur® 1520 A20 pMDI and 300 g of a polyether polyol started with propylene glycol and having an OH number of 28 and 85% primary OH groups, PO/EO ratio 50 wt. %/50 wt. %. The prepolymer had an NCO content of 23.8 wt. % and a viscosity of 1200 mPa.s (25° C.).

B. Gluing and Cold-Pressing of Veneers

Veneers of okoumé wood having a density of 0.4 to 0.5 g/m³ and a moisture content of approx. 5 to 7 wt. % abs. dry (absolutely dry wood) were used. Veneers 2.3 mm thick were used for the core layer and veneers 1.2 mm thick for the face layer. 7-ply laminates were produced from 5 core layer plies and 2 face layer plies as a veneer covering.

Veneers 450 mm×450 mm were supplied by way of a 4-roll gluing machine with 40 g prepolymer (20 g on the upper side and 20 g on the underside, corresponding to 100 g/m²). In order to improve processability, zeolite L powder was admixed with the prepolymer in some cases. The weight per unit area, approx. 100 g/m², was maintained in these cases. 8 g of water (corresponding to 20 g/m²) were sprayed onto each veneer after application of the prepolymer.

The laminate was cold-pressed at room temperature at a laminating pressure of from 5 to 10 bar. The laminate was, in this case, compressed to a height of approximately 15.3 mm. The time from commencement of gluing to commencement of compression was approximately 10 min., and the press time was 8 minutes.

C. Determination of Cold Bond Strength

The cold bond strength necessary for transport was tested by lifting the cold pre-pressed laminate bond, using a knife to lift the topmost veneer approximately 5 cm on one side after removal of the cauls. Depending on the degree of cold bond achieved, the bond held together or it fell apart into its individual veneers either immediately or after a delay. This was characterized as follows:

| Cold bond | |
|---|---|
| strength | Definition |
| 1 | Laminate bond falls apart spontaneously |
| 2 | Laminate bond falls apart after slight delay |
| | (after 1-3 seconds) |
| 3 | Laminate bond becomes detached after approximately |
| | 15 seconds |
| 4 | Laminate bond holds firmly together following lifting |
| 5 | Transportable, stable panel |

D. Hot-Pressing of the Glued Veneers

The glued, cold pre-pressed veneers were bonded firmly together by hot-pressing. The energy delivered by the press leads to cross-linking of the PU binder. A firm, hydrolytically stable PU binder joint is consequently created which mechanically bonds together the veneers on both sides of the glue line.

E. Determination of Binder Penetration and Technical Properties

After removal of the plywood from the hot press, the bond quality was checked visually on a bonded area (blistering, detachment of veneers). The penetration behavior (“strike-through”) of the binder to the plywood surface was also evaluated. In the case of the strike-through behavior, a distinction was made between the following three classifications:

| Strike- | |
|---|---|
| through | |
| as % | |
| 100%-10% | Strong strike-through of the binder to the surface |
| 10%-4% | Low strike-through of the binder to the surface |
| 3%-0% | No strike-through, optionally slight traces detectable where |
| | veneer defects were present |

The bond quality was finally established in a shear test. The samples were prepared in accordance with EN 314-1, Part 5.1.3. The samples were tested in accordance with EN 314-2—Class 3: Exterior. A zero value of an unmodified PU binder was also determined for comparative purposes.

The results are set out in the Table below:

| Binder | Bond strength | Strike-through | Shear resistance |
|---|---|---|---|
| Comparison Examples | | | |
| Desmodur ® 1520 | 1 | Strong | 2.14 N/mm² |
| A20 pMDI | | | |
| Prepolymer 6 | 1 | Strong | not determined |
| Prepolymer 7 | 1-2 | Strong | not determined |
| Examples according to the invention | | | |
| Prepolymer 1 | 5 | Nil | 2.11 N/mm² |
| Prepolymer 1A | 4-5 | Nil | 1.93 N/mm² |
| Prepolymer 1B | 4-5 | | 1.77 N/mm² |
| Prepolymer 1C | 4-5 | Nil | 1.92 N/mm² |
| Prepolymer 2 | 5 | Nil | 2.65 N/mm² |
| Prepolymer 3 | 4-5 | Low | 2.20 N/mm² |
| Prepolymer 4 | 5 | Nil | 2.51 N/mm² |
| Prepolymer 5 | 3 | Low | 2.10 N/mm² |

The laminates produced with the binders required in the present invention already had high bond strengths after pressing at room temperature. No strike-through of the binder was observable in the face layers.

Furthermore, some of the plywood laminates were also pre-treated and tested in accordance with EN 314-1, Part 5.1.4, in order to confirm potential for exterior use in accordance with EN 314-2. The tests showed the strength values of the plywoods produced by the process according to the invention to be influenced only slightly by the pre-treatment. It was established that the strength of the samples after preparation by boiling for 72 hours was only approximately 15% lower than that of samples prepared for the alternating boiling test. From these results it may be concluded that the hydrolytic resistance of the samples was good.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the production of a laminated material based on wood veneer comprising pressing veneers glued with a binder, optionally in combination with paper, cellulose or a woven web, in which the binder comprises a prepolymer having urethane groups and an NCO content of from 20 to 31 wt. %, which is the reaction product of a polyisocyanate of the diphenylmethane diisocyanate series with a hydroxy-functional polyether having an EO content of more than 60 wt. %, in relation to total quantity of alkylene oxide used to produce the polyether.

2. The process of claim 1 in which polymeric diphenylmethane diisocyanate having a monomeric diphenylmethane diisocyanate content of less than 55 wt. % is used as the polyisocyanate.

3. The process of claim 1 in which water is sprayed onto the veneer which is glued with binder.

4. The process of claim 1 in which the binder includes zeolite.

5. A laminated material based on wood veneer produced by the process of claim 1.
